(19) United States
(12) Patent Application Publication
(10) Pub. No.: US 2026/0155077 A1
(43) Pub. Date: Jun. 4, 2026

(54) DRIVING VOLTAGE ADJUSTMENT METHOD FOR DISPLAY DEVICE, ADJUSTMENT DEVICE AND ELECTRONIC DEVICE HAVING THE SAME

(71) Applicant: Samsung Display Co., Ltd., Yongin-si (KR)

(72) Inventor: Si Beak PYO, Yongin-si (KR)

(21) Appl. No.: 19/277,083

(22) Filed: Jul. 22, 2025

(30) Foreign Application Priority Data
Dec. 4, 2024 (KR) 10-2024-0178757

(51) Int. Cl. G09G 3/20; G09G 3/3233

(52) U.S. Cl. CPC G09G 3/2007; G09G 3/3233; G09G 2300/0439; G09G 2300/0819; G09G 2300/0842; G09G 2300/0861; G09G 2310/027; G09G 2320/0233; G09G 2320/0673; G09G 2330/021; G09G 2360/16

(57) ABSTRACT

A method for adjusting a driving voltage of a display device including a first pixel area having a first pixel density, and a second pixel area having a second pixel density greater than the first pixel density, includes: setting a plurality of low driving voltages corresponding to a plurality of reference brightnesses, respectively; performing an optical correction for a maximum grayscale of a first reference brightness of the plurality of reference brightnesses using a first low driving voltage corresponding to the first reference brightness from among the plurality of low driving voltages; and selectively changing the first low driving voltage based on a result of the optical correction.

### CROSS-REFERENCE TO RELATED APPLICATION

The present application claims priority to and the benefit of Korean Patent Application No. 10-2024-0178757, filed on Dec. 4, 2024, in the Korean Intellectual Property Office, the entire disclosure of which is incorporated by reference herein.

### BACKGROUND

### 1. Field

Aspects of embodiments of the present disclosure relate to a method for adjusting a driving voltage of a display device, an adjustment device, and an electronic device including the same.

### 2. Description of the Related Art

With the development of information technology, the importance of a display device, which is a connection medium between a user and information, is being highlighted. Accordingly, the use of display devices, such as liquid crystal display devices and organic light-emitting display devices, is increasing.

### SUMMARY

Embodiments of the present disclosure may be directed to a method for adjusting a driving voltage of a display device capable of achieving a target luminance, an adjustment device, and an electronic device including the same.

According to one or more embodiments of the present disclosure, a method for adjusting a driving voltage of a display device including a first pixel area having a first pixel density, and a second pixel area having a second pixel density greater than the first pixel density, includes: setting a plurality of low driving voltages corresponding to a plurality of reference brightnesses, respectively; performing an optical correction for a maximum grayscale of a first reference brightness of the plurality of reference brightnesses using a first low driving voltage corresponding to the first reference brightness from among the plurality of low driving voltages; and selectively changing the first low driving voltage based on a result of the optical correction.

In an embodiment, the performing of the optical correction for the maximum grayscale of the first reference brightness may include: receiving an optical characteristic measured in the first pixel area at the maximum grayscale of a plurality of grayscales; and correcting a gamma voltage of the first pixel area based on the optical characteristic.

In an embodiment, the selectively changing of the first low driving voltage based on the result of the optical correction may include: calculating a first data voltage required to emit light at the maximum grayscale to a first target luminance included in the first reference brightness; and determining whether or not the calculated first data voltage is greater than a reference data voltage.

In an embodiment, the selectively changing of the first low driving voltage based on the result of the optical correction may further include reducing the first low driving voltage by an offset value when the calculated first data voltage is less than or equal to the reference data voltage.

In an embodiment, the method may further include, after selectively changing the first low drive voltage based on the result of the optical correction, determining whether or not the reduced first low driving voltage is greater than a reference driving voltage.

In an embodiment, the method may further include, when the reduced first low driving voltage is greater than the reference driving voltage, re-performing the optical correction for the maximum grayscale of the first reference brightness using the reduced first low driving voltage.

In an embodiment, the method may further include, when the reduced first low driving voltage is less than or equal to the reference driving voltage, determining that an adjustment operation for the display device has failed.

In an embodiment, the method may further include, when the calculated first data voltage is greater than the reference data voltage, determining that an adjustment operation for the display device is successful.

In an embodiment, the method may further include, when the calculated first data voltage is greater than the reference data voltage: performing an optical correction for a maximum grayscale of a second reference brightness of the plurality of reference brightnesses using a second low driving voltage corresponding to the second reference brightness from among the plurality of low driving voltages; and selectively changing the second low driving voltage based on a result of the optical correction.

In an embodiment, the selectively changing of the second low driving voltage based on the result of the optical correction may include: calculating a second data voltage required to emit light at the maximum grayscale to a second target brightness included in the second reference brightness; and determining whether or not the calculated second data voltage is greater than the reference data voltage.

In an embodiment, the selectively changing of the second low driving voltage based on the result of the optical correction may further include reducing the second low driving voltage by an offset value when the calculated second data voltage is not greater than the reference data voltage.

In an embodiment, the method may further include, after selectively changing the second low driving voltage based on the result of the optical correction, determining whether or not the reduced second low driving voltage is greater than a reference driving voltage.

In an embodiment, the method may further include, when the reduced second low driving voltage is greater than the reference driving voltage, re-performing the optical correction for the maximum grayscale of the second reference brightness using the reduced second low driving voltage.

In an embodiment, the method may further include, when the reduced second low driving voltage is less than or equal to the reference driving voltage, determining that an adjustment operation for the display device has failed.

In an embodiment, the method may further include, when the calculated second data voltage is greater than the reference data voltage, determining that an adjustment operation for the display device is successful.

According to one or more embodiments of the present disclosure, an adjustment device includes: a measurement unit configured to measure an optical characteristic of a display device including a first pixel area having a first pixel density, and a second pixel area having a second pixel density greater than the first pixel density; a correction unit configured to correct a gamma voltage based on the optical characteristic of the first pixel area and/or the second pixel area in a plurality of grayscales; and a control unit configured to control the display device to selectively change a first low driving voltage corresponding to a first reference brightness among a plurality of reference brightnesses based on a result of the gamma voltage correction.

In an embodiment, the measurement unit may be configured to measure the optical characteristic of the first pixel area, the correction unit may be configured to correct the gamma voltage based on the optical characteristic of the first pixel area, and the control unit may be configured to reduce the low driving voltage by an offset value when a data voltage required to emit light at the maximum grayscale to a first target luminance included in the first reference luminance is less than or equal to a reference data voltage.

In an embodiment, when the reduced low driving voltage is less than or equal to a reference driving voltage, an adjustment operation for the display device may be determined to be failed.

In an embodiment, when the reduced low driving voltage is greater than a reference driving voltage, the correction unit may be configured to re-perform an operation of correcting the gamma voltage based on the optical characteristic of the first pixel area using the reduced driving voltage.

In an embodiment, an electronic device may include: a processor configured to provide input image data; and a display device configured to display an image based on the input image data, and including: a display panel including a plurality of first pixels corresponding to a first pixel area, and a plurality of second pixels corresponding to a second pixel area; a data driver configured to supply a data voltage to each of the plurality of first pixels and the plurality of second pixels; a scan driver configured to supply a scan signal to each of the plurality of first pixels and the plurality of second pixels; an emission driver configured to supply an emission control signal to each of the plurality of first pixels and the plurality of second pixels; and a power supply configured to supply a high driving voltage, and a low driving voltage lower than the high driving voltage to the display panel. The low driving voltage of the display device may be adjusted by the method for adjusting the driving voltage above.

However, the present disclosure is not limited to the above aspects and features, and the above and additional aspects and features will be set forth, in part, in the detailed description that follows with reference to the drawings, and in part, may be apparent therefrom, or may be learned by practicing one or more of the presented embodiments of the present disclosure.

### BRIEF DESCRIPTION OF THE DRAWINGS

The above and other aspects and features of the present disclosure will be more clearly understood from the following detailed description of the illustrative, non-limiting embodiments with reference to the accompanying drawings.

FIG. 1 is a diagram illustrating a display device according to an embodiment of the present disclosure.

FIG. 2 is a diagram illustrating a portion of a display panel of the display device of FIG. 1 according to an embodiment of the present disclosure.

FIG. 3 is a block diagram illustrating a display device according to an embodiment of the present disclosure.

FIG. 4A is a circuit diagram illustrating a pixel structure of a first pixel.

FIG. 4B is a circuit diagram illustrating a pixel structure of a second pixel.

FIG. 5 is a graph illustrating a change in a driving current according to a change in a second driving voltage.

FIG. 6 is a block diagram illustrating an adjustment device according to an embodiment of the present disclosure.

FIG. 7A is a flowchart illustrating a method of adjusting a display device according to an embodiment of the present disclosure.

FIG. 7B is a flowchart illustrating a method of adjusting a display device according to an embodiment of the present disclosure.

FIG. 8 is a block diagram of an electronic device according to an embodiment.

FIG. 9 is a schematic diagram of some electronic devices according to various embodiments.

### DETAILED DESCRIPTION

Hereinafter, embodiments will be described in more detail with reference to the accompanying drawings, in which like reference numbers refer to like elements throughout. The present disclosure, however, may be embodied in various different forms, and should not be construed as being limited to only the illustrated embodiments herein. Rather, these embodiments are provided as examples so that this disclosure will be thorough and complete, and will fully convey the aspects and features of the present disclosure to those skilled in the art. Accordingly, processes, elements, and techniques that are not necessary to those having ordinary skill in the art for a complete understanding of the aspects and features of the present disclosure may not be described. Unless otherwise noted, like reference numerals denote like elements throughout the attached drawings and the written description, and thus, redundant description thereof may not be repeated.

When a certain embodiment may be implemented differently, a specific process order may be different from the described order. For example, two consecutively described processes may be performed at the same or substantially at the same time, or may be performed in an order opposite to the described order.

Further, as would be understood by a person having ordinary skill in the art, in view of the present disclosure in its entirety, each suitable feature of the various embodiments of the present disclosure may be combined or combined with each other, partially or entirely, and may be technically interlocked and operated in various suitable ways, and each embodiment may be implemented independently of each other or in conjunction with each other in any suitable manner, unless otherwise stated or implied.

In the drawings, the relative sizes, thicknesses, and ratios of elements, layers, and regions may be exaggerated and/or simplified for clarity. Spatially relative terms, such as “beneath,” “below,” “lower,” “under,” “above,” “upper,” and the like, may be used herein for ease of explanation to describe one element or feature's relationship to another element(s) or feature(s) as illustrated in the figures. It will be understood that the spatially relative terms are intended to encompass different orientations of the device in use or in operation, in addition to the orientation depicted in the figures. For example, if the device in the figures is turned over, elements described as “below” or “beneath” or “under” other elements or features would then be oriented “above” the other elements or features. Thus, the example terms “below” and “under” can encompass both an orientation of above and below. The device may be otherwise oriented (e.g., rotated 90 degrees or at other orientations) and the spatially relative descriptors used herein should be interpreted accordingly.

Further, it should be expected that the shapes shown in the figures may vary in practice depending, for example, on tolerances and/or manufacturing techniques. Accordingly, the embodiments of the present disclosure should not be construed as being limited to the specific shapes shown in the figures, and should be construed considering changes in shapes that may occur, for example, as a result of manufacturing. As such, the shapes shown in the drawings may not depict the actual shapes of areas of the device, and the present disclosure is not limited thereto.

It will be understood that, although the terms “first,” “second,” “third,” etc., may be used herein to describe various elements, components, regions, layers and/or sections, these elements, components, regions, layers and/or sections should not be limited by these terms. These terms are used to distinguish one element, component, region, layer or section from another element, component, region, layer or section. Thus, a first element, component, region, layer or section described below could be termed a second element, component, region, layer or section, without departing from the spirit and scope of the present disclosure.

It will be understood that when an element or layer is referred to as being “on,” “connected to,” or “coupled to” another element or layer, it can be directly on, connected to, or coupled to the other element or layer, or one or more intervening elements or layers may be present. Similarly, when a layer, an area, or an element is referred to as being “electrically connected” to another layer, area, or element, it may be directly electrically connected to the other layer, area, or element, and/or may be indirectly electrically connected with one or more intervening layers, areas, or elements therebetween. In addition, it will also be understood that when an element or layer is referred to as being “between” two elements or layers, it can be the only element or layer between the two elements or layers, or one or more intervening elements or layers may also be present.

The terminology used herein is for the purpose of describing particular embodiments and is not intended to be limiting of the present disclosure. As used herein, the singular forms “a” and “an” are intended to include the plural forms as well, unless the context clearly indicates otherwise. It will be further understood that the terms “comprises,” “comprising,” “includes,” “including,” “has,” “have,” and “having,” when used in this specification, specify the presence of the stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. For example, the expression “A and/or B” denotes A, B, or A and B. Expressions such as “at least one of,” when preceding a list of elements, modify the entire list of elements and do not modify the individual elements of the list. For example, the expression “at least one of a, b, or c,” “at least one of a, b, and c,” and “at least one selected from the group consisting of a, b, and c” indicates only a, only b, only c, both a and b, both a and c, both b and c, all of a, b, and c, or variations thereof.

As used herein, the term “substantially,” “about,” and similar terms are used as terms of approximation and not as terms of degree, and are intended to account for the inherent variations in measured or calculated values that would be recognized by those of ordinary skill in the art. Further, the use of “may” when describing embodiments of the present disclosure refers to “one or more embodiments of the present disclosure.” As used herein, the terms “use,” “using,” and “used” may be considered synonymous with the terms “utilize,” “utilizing,” and “utilized,” respectively.

Unless otherwise defined, all terms (including technical and scientific terms) used herein have the same meaning as commonly understood by one of ordinary skill in the art to which the present disclosure belongs. It will be further understood that terms, such as those defined in commonly used dictionaries, should be interpreted as having a meaning that is consistent with their meaning in the context of the relevant art and/or the present specification, and should not be interpreted in an idealized or overly formal sense, unless expressly so defined herein.

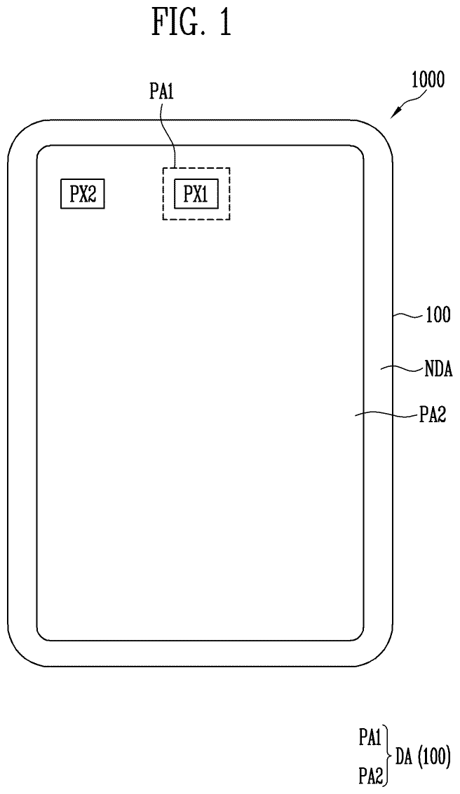

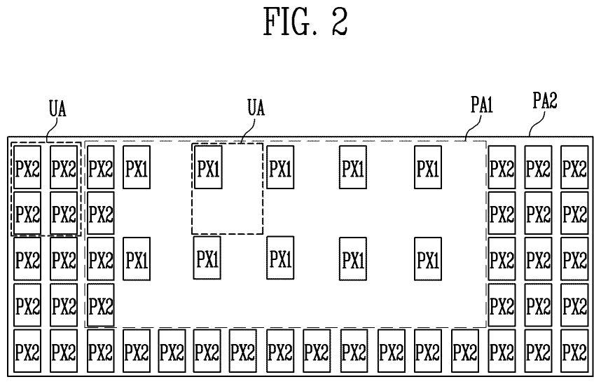

FIG. 1 is a diagram illustrating a display device 1000 according to an embodiment of the present disclosure. FIG. 2 is a diagram illustrating a portion of a display panel 100 of the display device 1000 of FIG. 1 according to an embodiment of the present disclosure.

Referring to FIGS. 1 and 2, the display device 1000 may include the display panel 100. The display panel 100 may include a display area DA and a non-display area NDA. First and second pixels PX1 and PX2 may be disposed in the display area DA, and various driving units (e.g., driving circuits or drivers) for driving the first and second pixels PX1 and PX2 may be disposed in the non-display area NDA.

The display area DA may include a first pixel area PA1 and a second pixel area PA2. The first pixels PX1 may be disposed in the first pixel area PA1, and the second pixels PX2 may be disposed in the second pixel area PA2.

In an embodiment, the size of a driving transistor included in the first pixel PX1 (e.g., a ratio of a channel width and a channel length) may be different from the size of a driving transistor included in the second pixel PX2 (e.g., a ratio of a channel width and a channel length). In an embodiment, as shown in FIG. 2, the number (e.g., density) of the first pixels PX1 arranged per unit area UA may be smaller than the number (e.g., density) of the second pixels PX2 arranged per unit area UA. For example, one first pixel PX1 per unit area UA may be disposed in the first pixel area PA1, and four second pixels PX2 per unit area UA may be disposed in the second pixel area PA2. In this case, the pixel density of the second pixel area PA2 may be four times that of the first pixel area PA1. In an embodiment, unlike that shown in FIG. 2, the pixel density of the second pixel area PA2 may be twice that of the first pixel area PA1.

As such, the resolution of the first pixel area PA1 may be lower than the resolution of the second pixel area PA2. Because the aperture ratio of the first pixel area PA1 may be higher than that of the second pixel area PA2, a camera, an optical sensor, or the like may be disposed to overlap with the first pixel area PA1. The optical sensor may include a biometric information sensor, such as a fingerprint sensor, an iris recognition sensor, and/or an arterial sensor. However, the present disclosure is not limited thereto, and the optical sensor of a light sensing method may include a gesture sensor, a motion sensor, a proximity sensor, an illuminance sensor, an image sensor, or the like.

The first pixel PX1 may supply more driving current than that of the second pixel PX2 corresponding to the same voltage. In this case, the same or substantially the same (or similar) luminance may be realized in the first pixel area PA1 and the second pixel area PA2 when a general grayscale (e.g., a grayscale value or level) is displayed in response to a data signal. As another example, the same or substantially the same (or similar) luminance may be realized in the first pixel area PA1 and the second pixel area PA2 by supplying data signals of different voltages to the first pixels PX1 and the second pixels PX2 in response to the same grayscale.

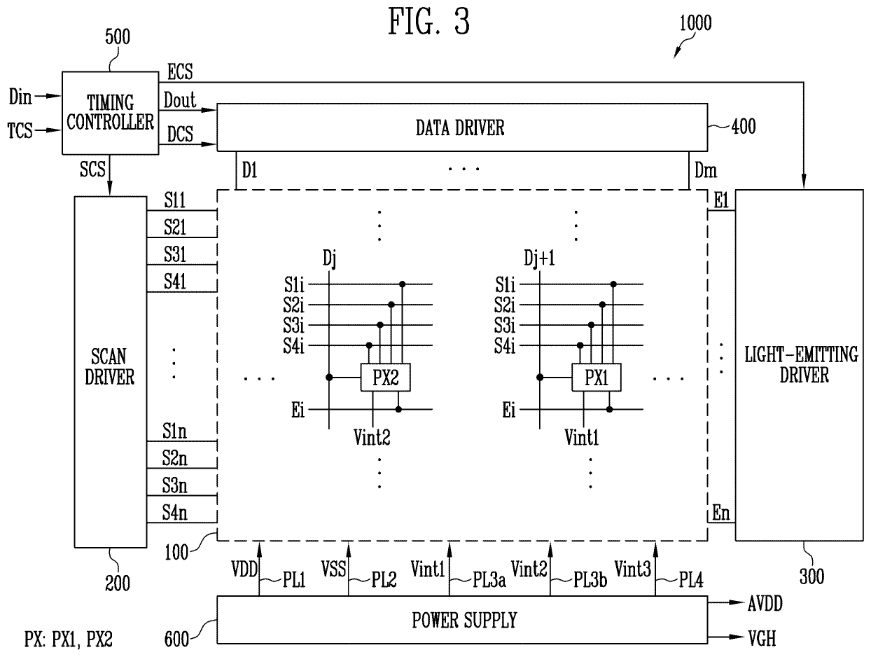

FIG. 3 is a block diagram illustrating the display device 1000 according to an embodiment of the present disclosure.

Referring to FIG. 3, the display device 1000 according to an embodiment of the present disclosure may include the display panel 100, a scan driver 200, a light-emitting driver 300, a data driver 400, a timing controller 500, and a power supply 600.

The display panel 100 may include scan lines S11 to S1n, S21 to S2n, S31 to S3n, and S41 to S4n, light-emitting control lines E1 to En, and data lines D1 to Dm (where n and m are integers greater than 1). Each of the pixels PX may include a driving transistor and a plurality of switching transistors.

In an embodiment, the display panel 100 may include the first pixel area PA1 and the second pixel area PA2 described above with reference to FIGS. 1 and 2. The first pixel area PA1 may include the first pixels PX1, and the second pixel area PA2 may include the second pixels PX2. The first pixels PX1 and the second pixels PX2 may have the same or substantially the same structure as each other.

The timing controller 500 may receive input data Din and a timing control signal TCS from a host system, such as an application processor (AP), through a suitable interface (e.g., a predetermined interface). The timing controller 500 may generate a first control signal SCS, a second control signal ECS, and a third control signal DCS in response to the timing control signal TCS. The first control signal SCS may be supplied to the scan driver 200, the second control signal ECS may be supplied to the light-emitting driver 300, and the third control signal DCS may be supplied to the data driver 400. Subsequently, the timing controller 500 may generate output data Dout by reordering and/or correcting the input data Din supplied from the outside, and may supply the output data Dout to the data driver 400.

The scan driver 200 may receive the first control signal SCS from the timing controller 500, and may supply a first scan signal to the first scan lines S11 to S1n, a second scan signal to the second scan lines S21 to S2n, a third scan signal to the third scan lines S31 to S3n, and a fourth scan signal to the fourth scan lines S41 to S4n, based on the first control signal SCS. The second scan lines S21 to S2n may be the same scan lines as the first scan lines S11 to S1n, and the fourth scan lines S41 to S4n may be the same scan lines as the third scan lines S31 to S3n. In addition, the fourth scan lines S41 to S4n may be the same scan lines as the first scan lines S11 to S1n.

The first to fourth scan signals may have (e.g., may be set to) a gate-on voltage corresponding to the kind of transistors to which the scan signals are supplied. The transistor receiving the scan signal may be in (e.g., may be set to) a turn-on state when the scan signal is supplied. For example, the gate-on voltage of the scan signal supplied to a P-channel metal oxide semiconductor (PMOS) transistor may be at a logic low level, and the gate-on voltage of the scan signal provided to an N-channel metal oxide semiconductor (NMOS) transistor may be a logic high level. Hereinafter, the phrase “scan signal is supplied” may be understood as the scan signal is supplied at a logic level that turns on the transistor controlled thereby.

In addition, when the first scan signal, the second scan signal, the third scan signal, and the fourth scan signal are not supplied, the scan driver 200 may supply a gate-off voltage VGH to the first scan lines S11 to S1n, the second scan lines S21 to S2n, the third scan lines S31 to S3n, and the fourth scan lines S41 to S4n. The gate-off voltage may have (e.g., may be set to) a voltage at which the transistors connected to the first scan lines S11 to S1n, the second scan lines S21 to S2n, the third scan lines S31 to S3n, and the fourth scan lines S41 to S4n are turned off. In an embodiment, the scan driver 200 may supply the same gate-off voltage VGH to the first pixel PX1 and the second pixel PX2.

The light-emitting driver 300 may receive the second control signal ECS from the timing controller 500, and may supply a light-emitting control signal to the light-emitting control lines E1 to En based on the second control signal ECS. For example, the light-emitting driver 300 may sequentially supply the light-emitting control signal to the light-emitting control lines E1 to En. The light-emitting control signal may be generated by the gate off voltage VGH, and the transistor receiving the light-emitting control signal may turn off. Hereinafter, the phrase “the light-emitting control signal is supplied” may be understood as the light-emitting control signals are supplied at a logic level that turns off the transistors controlled thereby.

In FIG. 3, the scan driver 200 is shown as a single component for convenience of illustration, but the present disclosure is not limited thereto. Depending on the design, the scan driver 200 may include a plurality of scan drivers, each supplying at least one of the first scan signal to the fourth scan signal. In addition, at least a portion of the scan driver 200 and/or the light-emitting driver 300 may be integrated into one driving circuit, module, or the like.

The data driver 400 may receive the third control signal DCS and the output data Dout from the timing controller 500. The data driver 400 may convert the digital output data Dout into an analog data signal (e.g., a data voltage) in response to the control of the data control signal DCS. The data driver 400 may supply data signals to the data lines D1 to Dm in response to the third control signal DCS. For example, the data driver 400 may supply the data signals to the data lines D1 to Dm to be synchronized with the first scan signals supplied to the first scan lines S1n to S11.

The data driver 400 may generate a gamma voltage by using the voltage of a driving power source AVDD, and may generate a data signal by using the gamma voltage. In addition, in some embodiments, the display device 1000 may further include a gamma driver configured to generate the gamma voltage by using the voltage of the driving power source AVDD, and to supply the generated gamma voltage to the data driver 400.

The power supply 600 may generate a first driving voltage VDD, a second driving voltage VSS, a first initialization voltage Vint1, a second initialization voltage Vint2, a third initialization voltage Vint3, the gate-off voltage VGH, and the driving power source AVDD.

The gate-off voltage VGH may be supplied to the scan driver 200 and/or the light-emitting driver 300. The gate-off voltage VGH may have (e.g., may set to) a voltage at which the transistors included in the pixels PX may be turned off. The driving power source AVDD may be supplied to the data driver 400. The driving power source AVDD may be used to generate the gamma voltage. In addition, the driving power source AVDD may be used for generating various voltages used for driving the display device 1000, and may be additionally supplied to various components of the display device 1000.

The first driving voltage VDD may be supplied to the pixels PX via a first power line PL1. The second driving voltage VSS may be supplied to the pixels PX via a second power line PL2. The first initialization voltage Vint1 may be supplied to the first pixels PX1 via a third power line PL3a (e.g., a 3a-th power line PL3a). The second initialization voltage Vint2 may be supplied to the second pixels PX2 via a third power line PL3b (e.g., a 3b-th power line PL3b). The third initialization voltage Vint3 may be supplied to the pixels PX via a fourth power line PL4.

In an embodiment, the first pixels PX1 and the second pixels PX2 may be commonly connected to the first power line PL1, the second power line PL2, and the fourth power line PL4. In addition, the first pixels PX1 may be connected to the 3a-th power line PL3a, and the second pixels PX2 may be connected to the 3b-th power line PL3b.

In other words, the first pixel PX1 is supplied with the first initialization voltage Vint1, and the second pixel PX2 is supplied with the second initialization voltage Vint2.

The first initialization voltage Vint1 may be a voltage for initializing a first electrode (e.g., the anode electrode) of a light-emitting device included in the first pixel PX1. The second initialization voltage Vint2 may be a voltage for initializing a first electrode of a light-emitting device included in the second pixel PX2. In an embodiment, the first initialization voltage Vint1 and the second initialization voltage Vint2 may have (e.g., may be set to) different voltages from each other. In an embodiment, the first initialization voltage Vint1 and the second initialization voltage Vint2 may have (e.g., may be set to) the same voltage as each other.

However, the present disclosure is not limited thereto, and the initialization voltage commonly and/or individually supplied to the first pixels PX1 and the second pixels PX2 may be variously modified as needed or desired.

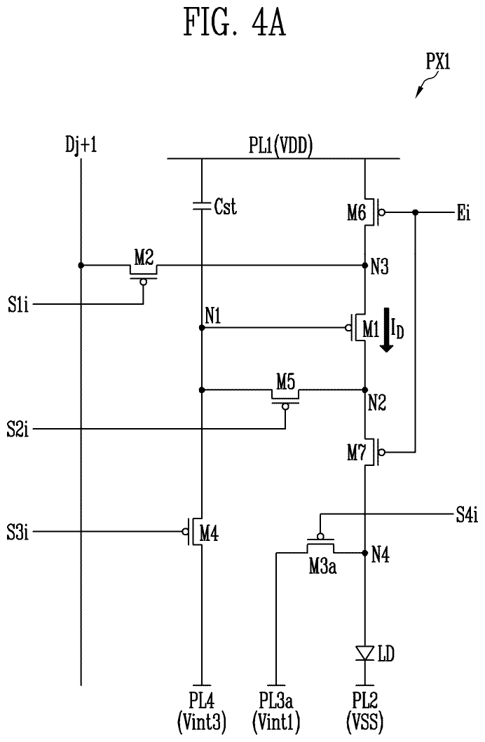

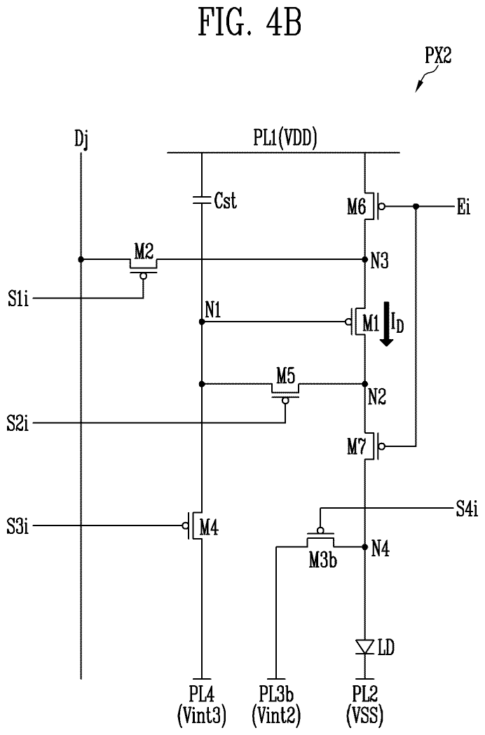

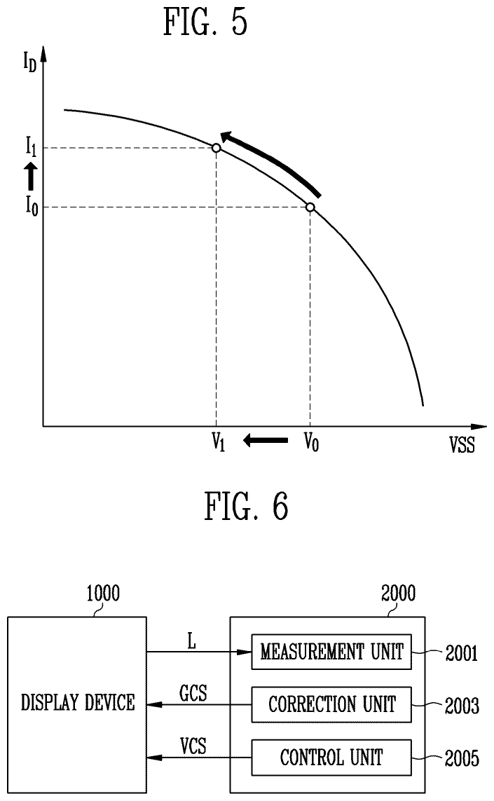

FIG. 4A is a circuit diagram illustrating a pixel structure of the first pixel PX1. FIG. 4B is a circuit diagram illustrating a pixel structure of the second pixel PX2. For convenience of illustration, FIG. 4A shows the first pixel PX1 located on an i-th horizontal line (e.g., an i-th pixel row), and connected to a j+1th data line Dj+1 (where i and j are integers equal to or greater than 1). FIG. 5B shows the second pixel PX2 located on the i-th horizontal line, and connected to a j-th data line Dj for convenience of illustration. Hereinafter with reference to FIGS. 4A and 4B, redundant description as those described above may not be repeated.

Referring to FIG. 4A, the first pixel PX1 according to an embodiment of the present disclosure includes a light-emitting device LD, and a pixel circuit for controlling an amount of current supplied to the light-emitting device LD.

A first electrode (e.g., an anode electrode) of the light-emitting device LD may be connected to the first power line PL1 to which the first driving voltage VDD is supplied via a fourth node N4, a seventh transistor M7, a first transistor M1, and a sixth transistor M6. A second electrode (e.g., a cathode electrode) of the light-emitting device LD may be connected to the second power line PL2 to which the second driving voltage VSS is supplied. The light-emitting device LD may generate light of a desired luminance (e.g., a predetermined luminance) in response to the amount of current supplied from the first transistor M1.

The light-emitting device LD may be an organic light-emitting diode. The light-emitting device LD may be an inorganic light-emitting diode, such as a micro light-emitting diode (LED) or a quantum dot light-emitting diode. The light-emitting device LD may be a device including a combination of organic and inorganic materials. In FIGS. 4A and 4B, the pixels PX1 and PX2 are shown as including a single light-emitting device LD, but in other embodiments, the pixels PX1 and PX2 may include a plurality of light-emitting devices. In this case, the plurality of light-emitting devices may be connected in series, in parallel, or in series and in parallel with each other.

The pixel circuit may include the first transistor M1 to the seventh transistor M7, and a storage capacitor Cst.

A first electrode of the first transistor M1 (e.g., the driving transistor) may be connected to a third node N3, and a second electrode thereof may be connected to a second node N2. In addition, a gate electrode of the first transistor M1 may be connected to a first node N1. The first transistor M1 may control the current amount of a driving current I_{D} supplied from the first driving voltage VDD to the second driving voltage VSS via the light-emitting device LD in response to the voltage of the first node N1. As such, the first driving voltage VDD may have (e.g., may be set to) a voltage higher than that of the second driving voltage VSS. Hereinafter, the first driving voltage VDD, which is a relatively high driving voltage, may also be referred to as a “high driving voltage”. Further, the second driving voltage VSS, which is a relatively low driving voltage, may also be referred to as a “low driving voltage”.

The second transistor M2 may be connected between the data line Dj+1 and the third node N3. The gate electrode of the second transistor M2 may be connected to the first scan line S1i. The second transistor M2 may be turned on when the first scan signal is supplied to the first scan line S1i to electrically connect the data line Dj+1 and the third node N3 to each other.

A fifth transistor M5 may be connected between the first node N1 and the second node N2. A gate electrode of the fifth transistor M5 may be connected to the second scan line S2i. The fifth transistor M5 may be turned on when the second scan signal is supplied to the second scan line S2i to electrically connect the first node N1 and the second node N2 to each other. When the fifth transistor M5 is turned on, the first transistor M1 may be connected in the form of a diode, or in other words, the first transistor M1 may be diode-connected.

A fourth transistor M4 may be connected between the first node N1 and the fourth power line PL4 to which the third initialization voltage Vint3 is supplied.

A gate electrode of the fourth transistor M4 may be connected to the third scan line S3i. The fourth transistor M4 may be turned on when the third scan signal is supplied to the third scan line S3i to supply the third initialization voltage Vint3 to the first node N1. The third initialization voltage Vint3 may have (e.g., may be set to) a voltage lower than that of the data signal supplied to the data line Dj+1.

The sixth transistor M6 may be connected between the first power line PL1 to which the first driving voltage VDD is supplied and the third node N3. A gate electrode of the sixth transistor M6 may be connected to the light-emitting control line Ei. The sixth transistor M6 may be turned off when the light-emitting control signal is supplied to the light-emitting control line Ei, and may be turned on in other cases.

The seventh transistor M7 may be connected between the second node N2 and the fourth node N4. The gate electrode of the seventh transistor M7 may be connected to the light-emitting control line Ei. The seventh transistor M7 may be turned off when the light-emitting control signal is supplied to the light-emitting control line Ei, and may be turned on in other cases. In FIG. 4A, the sixth transistor M6 and the seventh transistor M7 are illustrated as being connected to the same light-emitting control line Ei as each other, but the present disclosure is not limited thereto. In an embodiment, the sixth transistor M6 and the seventh transistor M7 may be connected to different light-emitting control lines Ei from each other.

A third transistor M3a may be connected between the fourth node N4 and the 3a-th power line PL3a to which the first initialization voltage Vint1 is supplied. A gate electrode of the third transistor M3a may be connected to the fourth scan line S4i. The third transistor M3a may be turned on when the fourth scan signal is supplied to the fourth scan line S4i to supply the first initialization voltage Vint1 to the fourth node N4.

The storage capacitor Cst may be connected between the first power line PL1 and the first node N1. The storage capacitor Cst may store a voltage applied to the first node N1.

In an embodiment, although the first transistor M1 to the seventh transistor M7 are illustrated as P-type transistors (e.g., PMOS transistors) in FIG. 4A, the present disclosure is not limited thereto. For example, at least one of the first transistor M1 to the seventh transistor M7 may include an N-type transistor (e.g., an NMOS transistor).

Referring to FIG. 4B, the second pixel PX2 according to an embodiment of the present disclosure includes a light-emitting device LD, and a pixel circuit for controlling a current amount of the driving current I_{D} supplied to the light-emitting device LD.

The second transistor M2 of the second pixel PX2 may be connected between the data line Dj and the third node N3. A third transistor M3b included in the second pixel PX2 may be connected between the fourth node N4 and the 3b-th power line PL3b to which the second initialization voltage Vint2 is supplied. A gate electrode of the third transistor M3b may be connected to the fourth scan line S4i.

The third transistor M3b may be turned on when the fourth scan signal is supplied to the fourth scan line S4i to supply the second initialization voltage Vint2 to the fourth node N4.

In an embodiment, the first electrode of the light-emitting device LD included in the first pixel PX1 may be initialized by the first initialization voltage Vint1, and the first electrode of the light-emitting device LD included in the second pixel PX2 may be initialized by the second initialization voltage Vint2.

When the first initialization voltage Vint1 or the second initialization voltage Vint2 is supplied to the first electrode of the light-emitting device LD, a parasitic capacitor of the light-emitting device LD may be discharged. An unintended micro-luminescence may be prevented or substantially prevented as the residual voltage charged in the parasitic capacitor of the light-emitting device LD is discharged.

FIG. 5 is a graph illustrating a change in the driving current I_{D} according to a change in the second driving voltage VSS.

The display device 1000 may set a reference brightness based on an ambient illuminance, a set brightness, or the like. The reference brightness may have (e.g., may be set to) one of a plurality of reference brightnesses. The higher the reference brightness of the display device 1000, the higher the luminance of the display panel when the same image data is displayed. Referring to Table 1 below, first to thirteenth reference brightnesses DBV1 to DBV13 and corresponding luminances are illustrated.

TABLE 1

| DBV | Luminance (Nits) | APL |
|---|---|---|
| DBV1 | 2500 | 30% |
| DBV2 | 1900 | 70% |
| DBV3 | 1200 | 100% |
| DBV4 | 700 | 100% |
| DBV5 | 300 | 100% |
| DBV6 | 180 | 100% |
| DBV7 | 120 | 100% |
| DBV8 | 90 | 100% |
| DBV9 | 50 | 100% |
| DBV10 | 30 | 100% |
| DBV11 | 15 | 100% |
| DBV12 | 10 | 100% |
| DBV13 | 5 | 100% |

Also, referring to Table 1, an average image level (hereinafter referred to as “APL”) corresponding to each reference brightness is illustrated. A peak luminance is the luminance measured at a portion that is driven to the highest luminance when some areas of the display device are driven to the highest luminance and the remaining surrounding areas are displayed in a black grayscale (e.g., a black grayscale level or value). A full white luminance is the luminance measured on the screen when the entire area of the display device is displayed at the highest luminance.

When the peak luminance and the full white luminance are set to be the same in a state where the reference brightness is high, for example, such as the first reference brightness DBV1, a visual fatigue by blinking the user's eyes may be increased. In addition, the full white luminance may be set lower than the peak luminance in order to reduce a power consumption at the high reference brightness.

The average image level (APL) limited at each reference brightness may be defined as a ratio of the area that emits a luminance corresponding to the reference brightness over the entire area of the display area. At the first reference brightness DBV1, a luminance of 2500 Nits may be limited to the average image level (APL) of 30%. In addition, at the second reference brightness DBV2, the luminance of 1900 Nits may be limited to the average image level (APL) of 70%. The average image level (APL) at the third to thirteenth reference brightnesses DBV3 to DBV13 may be 100%, and the peak luminance and the full white luminance may be the same.

However, Table 1 is provided as an example, and the number of reference brightnesses, the luminance, and the limited average image level corresponding to each reference brightness may be variously determined.

When the reference brightness DBV of the display device 1000 is high, a gate voltage margin of the first transistor M1, which is the driving transistor, may be insufficient. Referring to the circuit structure of the pixels PX1 and PX2 shown in FIGS. 4A and 4B, in order to increase the driving current I_{D} flowing through the first transistor M1 to the light-emitting device LD, the gate voltage may be lowered when a drain source voltage of the first transistor M1 is fixed. When the first transistor M1 is the PMOS transistor, there may be a limit to reducing the gate voltage. Therefore, the insufficient gate voltage margin may be compensated for by setting the second driving voltage VSS differently according to the reference brightness. Referring to FIG. 5, a change in the driving current I_{D} flowing through the first transistor M1 according to a change in the second driving voltage VSS, or in other words, the low driving voltage, is illustrated.

For example, the relatively low second driving voltage VSS may be set to generate the high driving current I_{D} at the relatively high reference brightness DBV. In other words, as shown in FIG. 5, when the value of the second driving voltage VSS is reduced from V₀ to V₁, the value of the driving current I_{D} may increase from I₀ to I₁ under the same gate voltage.

On the other hand, at the relatively low reference brightness DBV, the power consumption of the display device 1000 may be reduced by using the relatively high second driving voltage VSS.

In an embodiment, a second driving voltage value corresponding to any reference brightness may be determined, and second driving voltage values corresponding to different reference brightnesses may be respectively determined by using offsets (e.g., predetermined offsets). For example, the second driving voltage value corresponding to the fourth reference brightness DBV4 may be determined, and the second driving voltage values corresponding to each of the first to third reference brightnesses DBV1 to DBV3 and the fifth to thirteenth reference brightness DBV5 to DBV13 may be determined by using the offsets. In this case, an example of the offsets used to determine each reference brightness is illustrated in Table 2 below.

TABLE 2

| DBV | VSS offset (V) |
|---|---|
| DBV1 | −2.5 |
| DBV2 | −1.8 |
| DBV3 | −1.2 |
| DBV4 | 0.0 |
| DBV5 | 0.8 |
| DBV6 | 1.2 |
| DBV7 | 1.5 |
| DBV8 | 1.5 |
| DBV9 | 1.5 |
| DBV10 | 1.5 |
| DBV11 | 1.5 |
| DBV12 | 1.5 |
| DBV13 | 1.5 |

When the second driving voltage VSS corresponding to the fourth reference brightness DBV4 is −4.0 V, the second driving voltages VSS corresponding to the remaining reference brightnesses may be determined as shown in Table 3 below by using the offsets shown in Table 2.

TABLE 3

| DBV | VSS (V) |
|---|---|
| DBV1 | −6.5 |
| DBV2 | −5.8 |
| DBV3 | −5.2 |
| DBV4 | −4.0 |
| DBV5 | −3.2 |
| DBV6 | −2.8 |
| DBV7 | −2.5 |
| DBV8 | −2.5 |
| DBV9 | −2.5 |
| DBV10 | −2.5 |
| DBV11 | −2.5 |
| DBV12 | −2.5 |
| DBV13 | −2.5 |

The second driving voltage VSS for each reference brightness DBV illustrated in Table 3 above may be stored in the display device 1000 in the form of a lookup table. When the display device 1000 changes the reference brightness DBV according to an external control signal or an internal determination of the display device 1000, the second driving voltage VSS may be changed by referring to the lookup table shown in Table 3.

As described above, the density per unit area UA of the first pixel PX1 included in the first pixel area PA1 may be lower than the density per unit area UA of the second pixel PX2 included in the second pixel area PA2.

In order to prevent or substantially prevent the first pixel area PA1 from being viewed separately (or differently) from the second pixel area PA2, the luminance of the first pixel area PA1 and the luminance of the second pixel area PA2 may be the same or substantially the same as each other at a screen brightness (e.g., a specific or predetermined screen brightness). When the pixel density of the first pixel area PA1 is lower than that of the second pixel area PA2, in order to achieve the same or substantially the same luminance in the first and second pixel areas PA1 and PA2, the intensity of light generated by the individual first pixels PX1 included in the first pixel area PA1 may be stronger than the intensity of light produced by the individual second pixels PX2 included in the second pixel area PA2.

For example, when the pixel density of the first pixel area PA1 is half that of the second pixel area PA2, the intensity of light generated by each of the first pixels PX1 may be twice the intensity of light produced by each of the second pixels PX2 in order to achieve the same or substantially the same luminance in the first and second pixel areas PA1 and PA2.

When the reference brightness DBV of the display device 1000 is high, the gate voltage margin of the first pixel PX1, which may generate light higher than the second pixel PX2, may be insufficient. As described above with reference to the Tables 2 and 3, when the second driving voltage VSS corresponding to the relatively high reference brightness, for example, such as the first reference brightness DBV1 and the second reference brightness DBV2, is uniformly determined using the offset (e.g., the predetermined offset), the target luminance may not be achieved in the first pixel area PA1 of the display device 1000. This may increase a defect rate of the display device 1000.

According to an embodiment of the present disclosure, when the gate voltage margin of the pixel circuit for achieving the target luminance at the relatively high reference luminance is insufficient, an optical correction may be performed, while gradually lowering the second driving voltage, to achieve the target luminance. Accordingly, the defect rate of the display device 1000 may be reduced under the limited gate voltage condition and the limited second driving voltage condition.

FIG. 6 is a block diagram illustrating an adjustment device 2000 according to an embodiment of the present disclosure.

Referring to FIG. 6, the adjustment device 2000 may include a measurement unit (e.g., a measurement circuit) 2001, a correction unit (e.g., a correction circuit) 2003, and a control unit (e.g., a controller) 2005.

The measurement unit 2001 may measure an optical characteristic of the display device 1000. The optical characteristic of light L emitted by the display device 1000 may include a luminance and/or color coordinates. The measurement unit 2001 may be an optical device including a photographing means (e.g., a camera).

The display device 1000 may display an image by the signal (e.g., the data signal) generated based on the gamma voltage for each sub-pixel corresponding to a specific grayscale according to a gamma value (e.g., a predetermined gamma value). The gamma voltage of each sub-pixel corresponding to the specific grayscale may refer to a gamma voltage of a first sub-pixel, a gamma voltage of the second sub-pixel, and a gamma voltage of third sub-pixel corresponding to the specific grayscale. In this case, the first sub-pixel may correspond to a sub-pixel of a first color, the second sub-pixel may correspond to a sub-pixel of a second color, and the third sub-pixel may correspond to a sub-pixel of a third color.

The measurement unit 2001 may measure an optical characteristic of a portion of the display area DA that emits light at a specific grayscale. In an embodiment, the measurement unit 2001 may measure the optical characteristics of the first pixel area PA1 and the second pixel area PA2 shown in FIG. 1.

The correction unit 2003 may compare the optical characteristic measured by the measurement unit 2001 (hereinafter referred to as a “measured optical characteristic”) with a target optical characteristic. The target optical characteristic may be a target luminance and a target color coordinate corresponding to each grayscale according to a gamma curve (e.g., a predetermined gamma curve). The measured optical characteristic may be a measured luminance and a measured color coordinate obtained by measuring each grayscale image actually displayed in the display area DA according to a data signal generated based on a gamma voltage for each sub-pixel set in the target luminance and the target color coordinate.

The correction unit 2003 may determine whether or not the difference between the measured optical characteristic and the target optical characteristic (hereinafter referred to as an “optical characteristic difference”) is within a reference range, and may correct the gamma voltage so that the optical characteristic difference is within the reference range based on the determination result. In an embodiment, the gamma voltage correction may refer to a generation of correction data for the gamma voltage correction. The correction data may include an offset of the gamma voltage calculated based on the predetermined gamma curve.

The correction unit 2003 may correct the gamma voltage by determining a difference in optical characteristics for each of a plurality of reference grayscales. The correction unit 2003 may generate correction data to correct the gamma voltage by determining the difference in the optical characteristics for each of the plurality of reference grayscales. The correction unit 2003 may receive the measured optical characteristics from the measurement unit 2001 in each of the reference grayscales, and may generate the correction data to correct the gamma voltage according to a result of determining whether or not the difference in optical characteristics is within the reference range. The reference grayscale may be a grayscale selected from among the plurality of grayscales. In an embodiment, the reference grayscale may be selected grayscales (e.g., a grayscale level 255, a grayscale level 203, a grayscale level 152, a grayscale level 87, or the like) from among grayscale levels 0 to 255 (e.g., a total of 256 grayscale levels) having an Interval of 1 used in the display device 1000.

In an embodiment, the correction unit 2003 may correct the gamma voltage of each sub-pixel of the first pixel area PA1 based on the optical characteristic measured with respect to the first pixel area PA1 for each of the plurality of grayscales. On the other hand, the correction unit 2003 may correct the gamma voltage of each sub-pixel of the second pixel area PA2 based on the optical characteristic measured with respect to the second pixel area PA2.

In more detail, the correction unit 2003 may transmit a gamma control signal GCS to the display device 1000 to correct the gamma voltage of each sub-pixel of the display device 1000.

The adjustment device 2000 may repeatedly correct the gamma voltage. In an embodiment, the adjustment device 2000 may perform a Multi-Time Programming (MTP) operation that repeatedly corrects the gamma voltage of the display device 1000 in terms of a luminance and/or color coordinates. In other words, the MTP operation may be an iterative performance of the optical characteristic measurement and the gamma voltage correction. When the difference between the measured optical characteristic and the target optical characteristic exceeds the reference range, the voltage level of the gamma voltage may be compensated for or corrected (e.g., adjusted). Thereafter, the optical characteristic of the display device 1000 displaying an image according to a signal (e.g., a data signal) generated based on the compensated (or corrected) gamma voltage may be re-measured, and whether or not the difference between the re-measured optical characteristic and the target optical characteristic is within the reference range may be determined again. The adjustment device 2000 may repeatedly adjust the voltage level of the gamma voltage until the difference between the measured optical characteristic and the target optical characteristic falls within the reference range. When the difference between the measured optical characteristic and the target optical characteristic is within the reference range, the correction unit 2003 of the adjustment device 2000 may finally determine the corrected (e.g., the adjusted) gamma voltage. The adjustment device 2000 may correct the gamma voltage by performing the MTP operation on each of the plurality of reference grayscales.

In an embodiment, the gamma voltage correction of the second pixel area PA2 may be performed after the gamma voltage correction in the first pixel area PA1. In an embodiment, the gamma voltage correction in the first pixel area PA1 may be performed after the gamma voltage correction of the second pixel area PA2.

In some embodiments, the adjustment device 2000 may include a storage means (e.g., a memory or a storage device) for storing correction data generated by the correction unit 2003. The storage means may include (e.g., may be) a register that is programmed multiple times.

The control unit 2005 may generate a voltage control signal VCS for changing the second driving voltage VSS for each reference brightness DBV set in the display device 1000. The display device 1000 may change the second driving voltage VSS corresponding to the specific reference brightness DBV based on the received voltage control signal VCS. For example, the voltage control signal VCS may be a signal for changing the second driving voltage VSS corresponding to the specific reference brightness among the reference brightnesses included in Table 3 above.

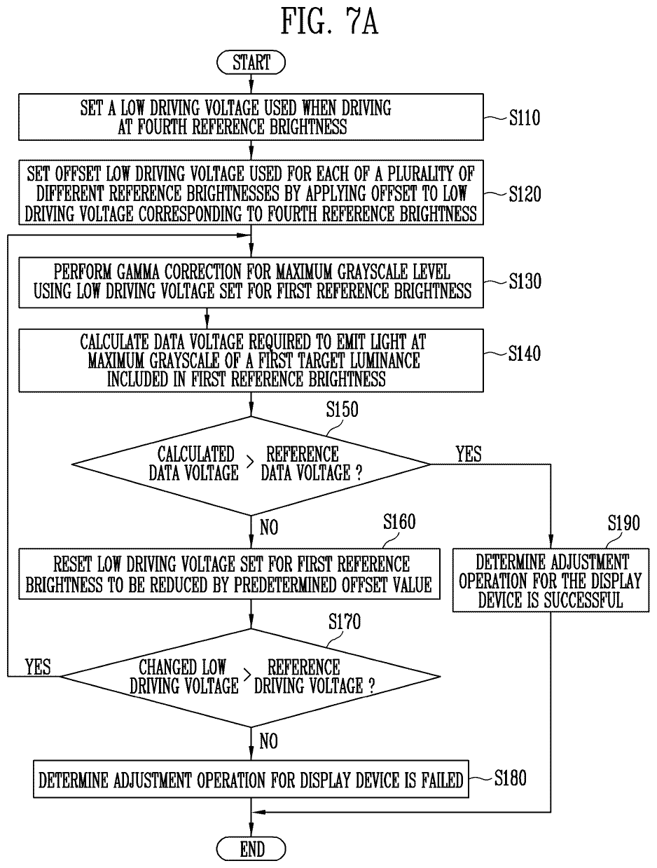

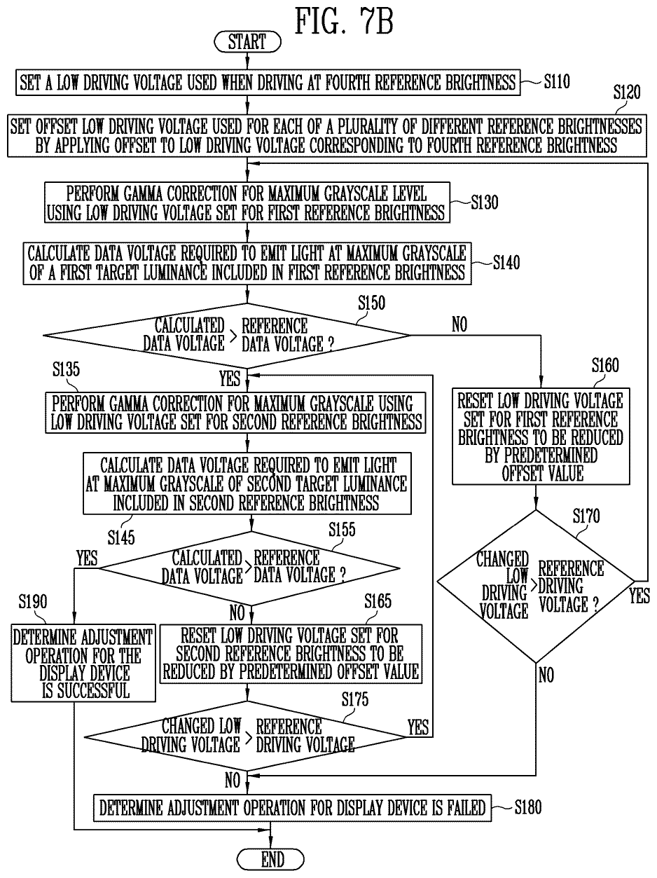

In more detail, when the gate voltage margin of the pixel circuit for achieving the target luminance at the relatively high reference brightness is insufficient, the adjustment device 2000 may perform the optical correction, while gradually lowering the second driving voltage VSS corresponding to the reference brightness. As such, the control unit 2005 may generate the voltage control signal VCS that controls the display device 1000 to gradually lower the second driving voltage VSS corresponding to the specific reference brightness, until the target luminance is achieved. This will be described in more detail below with reference to FIGS. 7A and 7B.

FIG. 7A is a flowchart illustrating a method of adjusting a display device according to an embodiment of the present disclosure. FIG. 7B is a flowchart illustrating a method of adjusting a display device according to an embodiment of the present disclosure. The method of adjusting the display device according to the flowcharts shown in FIGS. 7A and 7B may be performed by the adjustment device 2000 described above with reference to FIG. 6.

Referring to FIG. 7A, a method of adjusting a display device according to an embodiment of the present disclosure may start, and a low driving voltage used when driving at a fourth reference brightness may be set (S110). As described above with reference to Tables 2 and 3, the fourth reference brightness among the first to thirteenth reference brightnesses may be determined first. However, the present disclosure is not limited thereto. For example, a low driving voltage corresponding to any of the first through thirteenth reference brightnesses may be determined. In FIG. 7A, the low driving voltage may refer to the second driving voltage VSS supplied to the pixel circuit. According to the foregoing with reference to Table 2, in S110, it may be determined that the second driving voltage VSS corresponding to the fourth reference brightness DBV4 is −4.0 V.

An offset may be applied to the low driving voltage corresponding to the fourth reference brightness DBV4 to set the offset low driving voltage used for each of a plurality of different reference brightnesses (S120). For example, by applying the offset shown in Table 2 above, the low driving voltages corresponding to the reference brightnesses DBV1 to DBV3 and DBV5 to DBV13, other than the fourth reference brightness, may be set as shown in Table 3.

Using the low driving voltage set for the first reference brightness DBV1, a gamma correction for the maximum grayscale level may be performed (S130). When the grayscales used by the display device 1000 is from 0 to 255 (e.g., a total of 256 grayscale levels), the maximum grayscale level may be 255. In S130, the gamma correction for the white color of the grayscale level 255 may be performed. In S130, the gamma correction may be performed by an optical correction method. In other words, as described above with reference to FIG. 6, process S130 may be performed such that the measurement unit 2001 measures the characteristic of the light generated from the display device 1000, and the correction unit 2003 compares the light characteristic with the target light characteristic to set the gamma voltage.

A data voltage required to emit light at the maximum grayscale may be calculated with a first target luminance included in the first reference brightness DBV1 (S140). Referring to the example in Table 1 above, the first target luminance of the first reference brightness DBV1 may be 2500 Nits. As a result of the gamma correction in S130, the gamma voltage corresponding to the grayscale level 255, or in other words, the data voltage transmitted to the data line, may be calculated to achieve the first target luminance of 2500 Nits.

Whether or not the calculated data voltage is suitable to be used as the gate voltage of the first transistor M1, which is a driving transistor, may be determined. For example, when the lowest gate voltage level of the first transistor M1 considering the margin is 0.3 V, the first target luminance included in the first reference brightness DBV1 may be achieved when (e.g., only when) the data voltage calculated in S140 is greater than 0.3 V. Therefore, a determination may be made as to whether or not the calculated data voltage is greater than the reference data voltage (e.g., 0.3 V) (S150).

When the calculated data voltage is greater than the reference data voltage (S150: Yes), the adjustment operation for the display device 1000 may be determined to be successful (S190), as the display device 1000 may achieve the target luminance of the first reference brightness DBV1 without changing the low driving voltage, and the method may end.

When the calculated data voltage is less than or equal to the reference data voltage (S150: NO), the display device 1000 may not achieve the target luminance of the first reference brightness DBV1 without changing the low driving voltage. Therefore, the low driving voltage set for the first reference brightness DBV1 may be reset to be reduced by an offset value (e.g., a predetermined offset value) (S160). For example, as shown in Table 3, when the low driving voltage (e.g., the second driving voltage VSS) initially set for the first reference brightness DBV1 is −6.5 V, the offset value may be applied to set the low driving voltage set for the first reference brightness DBV1 to be less than −6.5 V. The offset value of S150 may be variously determined according to the design. The offset value may be determined to be a relatively large value in order to set the low driving voltage at which the target luminance may be achieved more quickly. The offset value may be determined to be a relatively small value in order to set the low driving voltage at which the target luminance may be more accurately achieved. For convenience of illustration, a case where the offset value is 0.1 V will be described in more detail below. In this case, in S160, the low driving voltage for the first reference brightness DBV1 may be changed from −6.5 V to −6.6 V.

A determination may be made whether or not the changed low driving voltage is greater than the reference driving voltage (S170). Even when the target luminance is not achieved by the calculated data voltage, the low driving voltage may not be lowered indefinitely. Therefore, the minimum limit value of the low driving voltage may be determined as the reference driving voltage, and it may be determined that the adjustment operation of the display device is successful when (e.g., only when) the reset low driving voltage is equal to or greater than the reference driving voltage. The reference driving voltage may be determined based on various limiting conditions. For example, the reference driving voltage may be determined in consideration of constraints for the power supply 600 to generate the second driving voltage VSS using the voltage of the driving power source AVDD. In an embodiment, the reference driving voltage may be −8.0 V. In this case, in S170, it may be determined whether or not the reset low driving voltage is greater than −0.8 V.

When the changed low driving voltage is greater than the reference driving voltage (S170: Yes), the method may return to S130, and the gamma correction for the maximum grayscale (e.g., the grayscale level 255) using the changed low driving voltage may be performed. Subsequently, while repeatedly performing the processes S140, S150, S160, and S170, the low driving voltage may be repeatedly reduced by the offset value, until the data voltage for achieving the target luminance is calculated to be higher than the reference data voltage. In other words, each time the processes S130, S140, S150, S160, and S170 are performed, the low driving voltage may be reset so as to be decreased by 0.1 V. When it is determined that the calculated data voltage is greater than the reference data voltage as a result of performing the gamma correction while the low driving voltage gradually decreases (S150: Yes), the adjustment operation for the display device is determined to be successful (S190), and the method may end. For example, assume that the calculated data voltage is determined to be greater than the reference data voltage when the low driving voltage gradually decreases from −6.5 V to −7.2 V by 0.1 V at a time. Thereafter, when the display device 1000 operates at the first reference brightness DBV1, the low driving voltage may be set to −7.2 V. In other words, the display device 1000 may use the low driving voltage (e.g., the second driving voltage VSS) corresponding to each reference brightness, as shown in Table 4 below.

TABLE 4

| DBV | VSS (V) |
|---|---|
| DBV13 | −7.2 |
| DBV12 | −5.8 |
| DBV11 | −5.2 |
| DBV10 | −4.0 |
| DBV9 | −3.2 |
| DBV8 | −2.8 |
| DBV7 | −2.5 |
| DBV6 | −2.5 |
| DBV5 | −2.5 |
| DBV4 | −2.5 |
| DBV3 | −2.5 |
| DBV2 | −2.5 |
| DBV1 | −2.5 |

Referring to Table 3 and Table 4, the second driving voltage VSS for each reference brightness may be set as shown in Table 3 in S120 at the beginning of the operation of the method of FIG. 7A. Each time the processes S130, S140, S150, S160, and S170 are performed, the low driving voltage corresponding to the first reference brightness DBV1 decreases by 0.1 V, and it is determined that the data voltage calculated as a result of the gamma correction performed after the low driving voltage corresponds to the first reference luminance DBV1 becomes −7.2 V is greater than the reference data voltage (S150: Yes), and thus, the adjustment operation for the display device is determined to be successful.

When the changed low driving voltage is less than or equal to the reference driving voltage (S170: No), the low driving voltage is set lower than the reference driving voltage without achieving the first target luminance despite repeated resetting of the low driving voltage. In other words, because a value lower than the minimum low driving voltage that may be used by the display device 1000 is calculated, it may be determined that the adjustment operation for the display device 1000 has failed (S180), and the method may end. As a result, the display device 1000 may be treated as being defective.

As described above, according to an embodiment of the present disclosure, when the gate voltage margin of the pixel circuit for achieving the target luminance is insufficient at the relatively high reference brightness, for example, such as the first reference brightness, the optical correction may be performed while gradually lowering the second driving voltage to achieve the target luminance. Accordingly, the defect rate of the display device 1000 may be reduced under the limited gate voltage condition and the limited second driving voltage condition.

On the other hand, the gamma correction, or in other words, the optical correction performed in S130 of FIG. 7A may be performed with respect to the first pixels PX1 of the first pixel area PA1. As described above, in order to achieve the same or substantially the same luminance, the first transistor M1 included in the first pixels PX1 of the first pixel area PA1 with the lower pixel density may have to generate the larger driving current I_{D}, so that the gate voltage margin may likely be insufficient.

The gamma correction (or optical correction) may be performed with respect to the second pixel area PA2 immediately before S190 in FIG. 7A. Because the second driving voltage VSS used for the first reference brightness DBV1 has changed by repeatedly performing operations S130, S140, S150, S160, and S170 as described above, the gamma correction (or optical correction) may be performed again with respect to the second area PA2 under the changed second driving voltage VSS.

FIG. 7A illustrates an embodiment in which the second driving voltage corresponding to the first reference brightness DBV1 is adaptively determined, but the present disclosure is not limited thereto. For example, the second driving voltage corresponding to the second reference brightness DBV2 in addition to the first reference brightness DBV1 may also be determined in a similar manner. This will be described in more detail below with reference to FIG. 7B. Hereinafter with reference to FIG. 7B, redundant description as those described above with reference to FIG. 7A may not be repeated.

Referring to FIG. 7B, the method of adjusting the display device according to an embodiment of the present disclosure may start, and the low driving voltage used when driving at the fourth reference brightness may be set (S110). The offset may be applied to the low driving voltage corresponding to the determined fourth reference brightness DBV4 to set the offset low driving voltage used for each of the plurality of different reference brightnesses (S120). The gamma correction may be performed on the maximum grayscale using the low driving voltage set for the first reference brightness DBV1 (S130). The data voltage required to emit light at the maximum grayscale may be calculated with the first target luminance included in the first reference brightness DBV1 (S140). Subsequently, a determination may be made whether or not the calculated data voltage is greater than the reference data voltage (e.g., 0.3 V) (S150). When the calculated data voltage is less than or equal to the reference data voltage (S150: No), the low driving voltage set for the first reference brightness DBV1 may be reset to be reduced by an offset value (e.g., a predetermined offset value) (S160), and a determination may be made whether or not the changed low driving voltage is greater than the reference driving voltage (S170). When the changed low driving voltage is greater than the reference driving voltage (S170: Yes), the method may return to operation S130, and the gamma correction for the maximum grayscale (e.g., the grayscale level 255) using the changed low driving voltage may be performed. When the changed low driving voltage is less than or equal to the reference driving voltage (S170: No), it may be determined that the adjustment operation for the display device 1000 has failed (S180), and the method may end. The foregoing may be the same or substantially the same as that of the method described above with reference to FIG. 7A.

As a result of the determination in S150, when the data voltage that achieves the first target luminance of the first reference brightness DBV1 is greater than the reference data voltage (S150: YES), the low driving voltage corresponding to the first reference brightness DMV1 may be in a state in which the change is completed. Therefore, a reset operation of the low driving voltage corresponding to the second reference brightness DBV2 may be performed (S135).

In more detail, when the data voltage that achieves the first target luminance of the first reference brightness DBV1 is greater than the reference data voltage (S150: YES), the gamma correction for the maximum grayscale may be performed using the low driving voltage set for the second reference brightness DBV2 (S135).

Subsequently, the data voltage required to emit light at the maximum grayscale of the second target luminance included in the second reference brightness DBV2 may be calculated (S145). Referring to the example in Table 1 above, the second target luminance of the second reference brightness DBV1 may be 1900 Nits. As a result of the gamma correction in S130, the gamma voltage corresponding to the grayscale level 255, or in other words, the data voltage transmitted to the data line, may be calculated to achieve the second target luminance of 1900 Nits.

A determination may be made whether or not the calculated data voltage is suitable to be used as the gate voltage of the first transistor M1, which is a driving transistor. For example, when the lowest gate voltage level of the first transistor M1 considering the margin is 0.3 V, the second target luminance included in the second reference brightness DBV2 may be achieved when (e.g., only when) the data voltage calculated in S145 is greater than 0.3 V. Therefore, whether or not the calculated data voltage is greater than the reference data voltage (e.g., 0.3 V) may be determined (S155).

When the calculated data voltage is greater than the reference data voltage (S155: Yes), the display device 1000 may achieve the second target luminance of the second reference brightness DBV2 without changing the low driving voltage. Because both the first target brightness of the first reference brightness DBV1 and the second target brightness of the second reference brightness DBV2 may be achieved, the adjustment operation for the display device 1000 may be determined to be successful (S190), and the method may end.

When the calculated data voltage is less than or equal to the reference data voltage (S155: No), the display device 1000 may not achieve the target luminance of the second reference brightness DBV2 without changing the low driving voltage. Therefore, the low driving voltage set for the second reference brightness DBV2 may be reset to be reduced by the predetermined offset value (S165). For example, as shown in Table 3 above, when the low driving voltage (e.g., the second driving voltage VSS) initially set for the second reference brightness DBV2 is −5.8V, the offset value may be applied to set the low driving voltage set for the second reference brightness DBV2 to be less than −5.8V. Hereinafter, for convenience of illustration, a case where the offset value of S165 is −0.1 V will be described in more detail. In this case, in S165, the low driving voltage for the second reference brightness DBV2 may be changed from −5.8 V to −5.9 V.

Subsequently, a determination may be made whether or not the changed low driving voltage is greater than the reference driving voltage (S175). In an embodiment, the reference driving voltage may be −8.0 V. In this case, in S175, it may be determined whether or not the reset low driving voltage is greater than −0.8 V.

When the changed low driving voltage is greater than the reference driving voltage (S175: Yes), the method may return to S135, and the gamma correction for the maximum grayscale (e.g., the grayscale level 255) using the changed low driving voltage may be performed. Subsequently, while repeatedly performing operations S145, S155, S165, and S175, the low driving voltage may be repeatedly reduced by the offset value until the data voltage for achieving the second target luminance with respect to the second reference brightness DBV2 is calculated to be higher than the reference data voltage. In other words, each time the operations S135, S145, S155, S165, and S175 are performed, the low driving voltage corresponding to the second reference brightness DBV2 may be reset so as to be decreased by 0.1 V. When it is determined that the calculated data voltage is greater than the reference data voltage as a result of performing the gamma correction while the low driving voltage gradually decreases (S155: Yes), the adjustment operation for the display device may be determined to be successful (S190), and the method may end. For example, the calculated data voltage may be determined to be greater than the reference data voltage when the low driving voltage gradually decreases from −5.8 V to −6.1 V in 0.1 V increments. Thereafter, when the display device 1000 operates at the second reference brightness DBV2, the low driving voltage may be set to −6.1 V. In summary, the display device 1000 may use the low driving voltage (e.g., the second driving voltage VSS) corresponding to each reference brightness, as shown in Table 5 below.

TABLE 5

| DBV | VSS (V) |
|---|---|
| DBV13 | −7.2 |
| DBV12 | −6.1 |
| DBV11 | −5.2 |
| DBV10 | −4.0 |
| DBV9 | −3.2 |
| DBV8 | −2.8 |
| DBV7 | −2.5 |
| DBV6 | −2.5 |
| DBV5 | −2.5 |
| DBV4 | −2.5 |
| DBV3 | −2.5 |
| DBV2 | −2.5 |
| DBV1 | −2.5 |

According to an embodiment of the present disclosure, when the gate voltage margin of the pixel circuit for achieving the target luminance is insufficient at a plurality of relatively high reference brightnesses, for example, such as the first reference brightness DBV1 and/or the second reference brightness DBV2, the optical correction may be performed while gradually lowering the second driving voltage corresponding to each of the reference brightnesses to achieve the target luminance. Accordingly, the defect rate of the display device 1000 may be reduced under the limited gate voltage condition and the limited second driving voltage condition.

In FIG. 7B, an embodiment in which the second driving voltage VSS corresponding to the first reference brightness DBV and the second reference brightness DBV2, or in other words, the low driving voltage, may be determined is illustrated, but the present disclosure is not limited thereto. For example, the second driving voltages corresponding to three or more reference brightnesses may also be set in a similar manner as those described above with reference to FIGS. 7A and 7B.

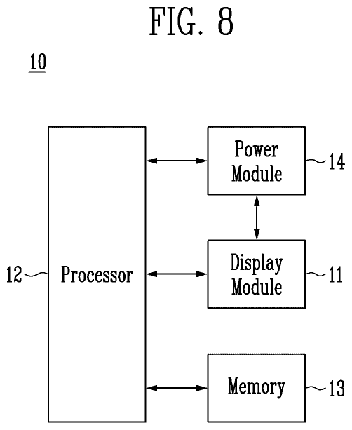

FIG. 8 is a block diagram of an electronic device 10 according to an embodiment. Referring to FIG. 8, the electronic device 10 according to an embodiment may include a display module 11, a processor 12, a memory 13, and a power module 14.

The processor 12 may include at least one of a central processing unit (CPU), an application processor (AP), a graphics processing unit (GPU), a communication processor (CP), an image signal processor (ISP), and/or a controller.

The memory 13 may store data information used for the operations of the processor 12 or the display module 11. When the processor 12 executes the application stored in the memory 13, the image data signal and/or the input control signal may be transmitted to the display module 11, and the display module 11 may process the received signal and output the image information through the display screen.

The power module 14 may include a power supply, such as a power adapter or a battery device, and a power conversion module that converts power supplied by the power supply module to generate power used for the operation of the electronic device 10.

At least one of the above-described components of the electronic device 10 may be included in the display device according to the above-described embodiments. In addition, some of the individual modules that are functionally included in one module may be included in the display device, and others may be provided separately from the display device. For example, the display device include may include the display module 11, and the processor 12, the memory 13, and the power module 14 may be provided in the form of other devices in the electronic device 10 other than the display device. In more detail, the display device including the display module 11 may be a display device in which the second driving voltage is adjusted by the adjustment device 2000 of FIG. 6.

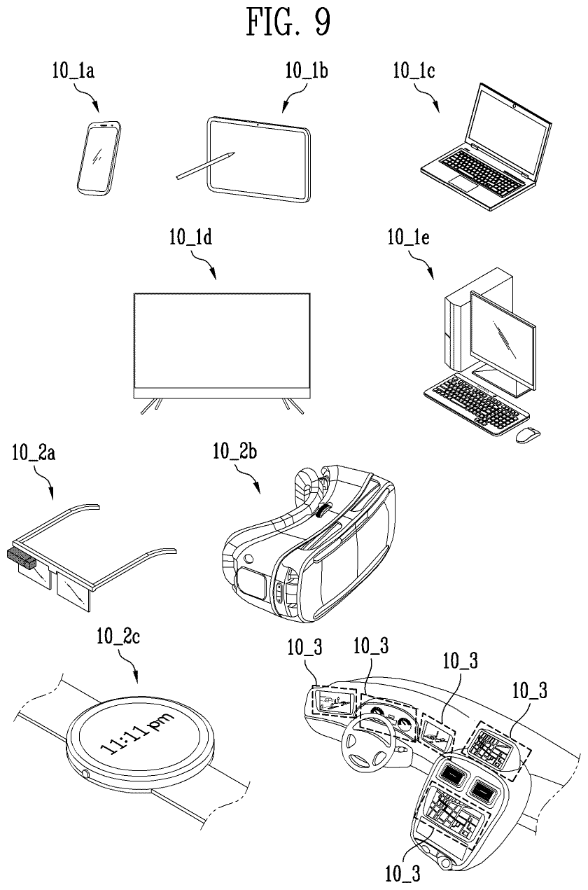

FIG. 9 is a schematic diagram of some electronic devices according to various embodiments.

Referring to FIG. 9, various electronic devices to which a display device according to some embodiments may be applied may include not only an electronic device for displaying an image, such as a smartphone 10_1a, a tablet PC 10_1b, a laptop 10_1c, a TV 10_1d, and a desk monitor 10_1e, but also a wearable electronic device including a display module, such as smart glasses 10_2a, a head mounted display 10_2b, and a smart watch 10_2c. The electronic device may be for a vehicle 10_3 including a display module, such as a Center Information Display (CID) and a room mirror display, disposed on an instrument panel, a center fascia, a dashboard of a vehicle, and the like.

The electronic or electric devices and/or any other relevant devices or components according to embodiments of the present disclosure described herein (e.g., the measurement unit, the correction unit, the control unit, and the like) may be implemented utilizing any suitable hardware, firmware (e.g. an application-specific integrated circuit), software, or a combination of software, firmware, and hardware. For example, the various components of these devices may be formed on one integrated circuit (IC) chip or on separate IC chips. Further, the various components of these devices may be implemented on a flexible printed circuit film, a tape carrier package (TCP), a printed circuit board (PCB), or formed on one substrate. Further, the various components of these devices may be a process or thread, running on one or more processors, in one or more computing devices, executing computer program instructions and interacting with other system components for performing the various functionalities described herein. The computer program instructions are stored in a memory which may be implemented in a computing device using a standard memory device, such as, for example, a random access memory (RAM). The computer program instructions may also be stored in other non-transitory computer readable media such as, for example, a CD-ROM, flash drive, or the like. Also, a person of skill in the art should recognize that the functionality of various computing devices may be combined or integrated into a single computing device, or the functionality of a particular computing device may be distributed across one or more other computing devices without departing from the spirit and scope of the example embodiments of the present disclosure.

The foregoing is illustrative of some embodiments of the present disclosure, and is not to be construed as limiting thereof. Although some embodiments have been described, those skilled in the art will readily appreciate that various modifications are possible in the embodiments without departing from the spirit and scope of the present disclosure. It will be understood that descriptions of features or aspects within each embodiment should typically be considered as available for other similar features or aspects in other embodiments, unless otherwise described. Thus, as would be apparent to one of ordinary skill in the art, features, characteristics, and/or elements described in connection with a particular embodiment may be used singly or in combination with features, characteristics, and/or elements described in connection with other embodiments unless otherwise specifically indicated. Therefore, it is to be understood that the foregoing is illustrative of various example embodiments and is not to be construed as limited to the specific embodiments disclosed herein, and that various modifications to the disclosed embodiments, as well as other example embodiments, are intended to be included within the spirit and scope of the present disclosure as defined in the appended claims, and their equivalents.

What is claimed is:

1. A method for adjusting a driving voltage of a display device comprising a first pixel area having a first pixel density, and a second pixel area having a second pixel density greater than the first pixel density, the method comprising:
setting a plurality of low driving voltages corresponding to a plurality of reference brightnesses, respectively;
performing an optical correction for a maximum grayscale of a first reference brightness of the plurality of reference brightnesses using a first low driving voltage corresponding to the first reference brightness from among the plurality of low driving voltages; and
selectively changing the first low driving voltage based on a result of the optical correction.

2. The method of claim 1, wherein the performing of the optical correction for the maximum grayscale of the first reference brightness comprises:
receiving an optical characteristic measured in the first pixel area at the maximum grayscale of a plurality of grayscales; and
correcting a gamma voltage of the first pixel area based on the optical characteristic.

3. The method of claim 1, wherein the selectively changing of the first low driving voltage based on the result of the optical correction comprises:
calculating a first data voltage required to emit light at the maximum grayscale to a first target luminance included in the first reference brightness; and
determining whether or not the calculated first data voltage is greater than a reference data voltage.

4. The method of claim 3, wherein the selectively changing of the first low driving voltage based on the result of the optical correction further comprises reducing the first low driving voltage by an offset value when the calculated first data voltage is less than or equal to the reference data voltage.

5. The method of claim 4, further comprising, after selectively changing the first low drive voltage based on the result of the optical correction, determining whether or not the reduced first low driving voltage is greater than a reference driving voltage.

6. The method of claim 5, further comprising, when the reduced first low driving voltage is greater than the reference driving voltage, re-performing the optical correction for the maximum grayscale of the first reference brightness using the reduced first low driving voltage.

7. The method of claim 5, further comprising, when the reduced first low driving voltage is less than or equal to the reference driving voltage, determining that an adjustment operation for the display device has failed.

8. The method of claim 3, further comprising, when the calculated first data voltage is greater than the reference data voltage, determining that an adjustment operation for the display device is successful.

9. The method of claim 3, further comprising, when the calculated first data voltage is greater than the reference data voltage:
performing an optical correction for a maximum grayscale of a second reference brightness of the plurality of reference brightnesses using a second low driving voltage corresponding to the second reference brightness from among the plurality of low driving voltages; and
selectively changing the second low driving voltage based on a result of the optical correction.

10. The method of claim 9, wherein, the selectively changing of the second low driving voltage based on the result of the optical correction comprises:
calculating a second data voltage required to emit light at the maximum grayscale to a second target brightness included in the second reference brightness; and
determining whether or not the calculated second data voltage is greater than the reference data voltage.

11. The method of claim 10, wherein the selectively changing of the second low driving voltage based on the result of the optical correction further comprises reducing the second low driving voltage by an offset value when the calculated second data voltage is not greater than the reference data voltage.

12. The method of claim 11, further comprising, after selectively changing the second low driving voltage based on the result of the optical correction, determining whether or not the reduced second low driving voltage is greater than a reference driving voltage.

13. The method of claim 12, further comprising, when the reduced second low driving voltage is greater than the reference driving voltage, re-performing the optical correction for the maximum grayscale of the second reference brightness using the reduced second low driving voltage.

14. The method of claim 12, further comprising, when the reduced second low driving voltage is less than or equal to the reference driving voltage, determining that an adjustment operation for the display device has failed.

15. The method of claim 10, further comprising, when the calculated second data voltage is greater than the reference data voltage, determining that an adjustment operation for the display device is successful.

16. An adjustment device comprising:
a measurement unit configured to measure an optical characteristic of a display device comprising a first pixel area having a first pixel density, and a second pixel area having a second pixel density greater than the first pixel density;
a correction unit configured to correct a gamma voltage based on the optical characteristic of the first pixel area and/or the second pixel area in a plurality of grayscales; and
a control unit configured to control the display device to selectively change a first low driving voltage corresponding to a first reference brightness among a plurality of reference brightnesses based on a result of the gamma voltage correction.

17. The adjustment device according to claim 16,
wherein the measurement unit is configured to measure the optical characteristic of the first pixel area,
wherein the correction unit is configured to correct the gamma voltage based on the optical characteristic of the first pixel area, and
wherein the control unit is configured to reduce the low driving voltage by an offset value when a data voltage required to emit light at the maximum grayscale to a first target luminance included in the first reference luminance is less than or equal to a reference data voltage.

18. The adjustment device according to claim 17, wherein, when the reduced low driving voltage is less than or equal to a reference driving voltage, an adjustment operation for the display device is determined to be failed.

19. The adjustment device according to claim 17, wherein, when the reduced low driving voltage is greater than a reference driving voltage, the correction unit is configured to re-perform an operation of correcting the gamma voltage based on the optical characteristic of the first pixel area using the reduced driving voltage.

20. An electronic device comprising:
a processor configured to provide input image data; and
a display device configured to display an image based on the input image data, and comprising:
a display panel comprising a plurality of first pixels corresponding to a first pixel area, and a plurality of second pixels corresponding to a second pixel area;
a data driver configured to supply a data voltage to each of the plurality of first pixels and the plurality of second pixels;
a scan driver configured to supply a scan signal to each of the plurality of first pixels and the plurality of second pixels;
an emission driver configured to supply an emission control signal to each of the plurality of first pixels and the plurality of second pixels; and
a power supply configured to supply a high driving voltage, and a low driving voltage lower than the high driving voltage to the display panel,
wherein the low driving voltage of the display device is adjusted by the method for adjusting the driving voltage according to claim 1.
